(19) United States
(12) Patent Application Publication
(10) Pub. No.: US 2002/0188384 A1
(43) Pub. Date: Dec. 12, 2002

(54) Method and apparatus for distributed computation using vehicle computers

(75) Inventors: Craig Henry Becker, Austin, TX (US); William W. Lawton, Georgetown, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 09/876,088

(22) Filed: Jun. 7, 2001

(51) Int. Cl. G06F 9/00; G06F 17/00; G06F 7/00; G05D 3/00; G05D 1/00

(52) U.S. Cl. 701/1

(57) ABSTRACT

A method, apparatus, and computer implemented instructions for distributed computing in a data processing system located in a vehicle. Monitoring for a condition in which processing resources are available in the data processing system is performed. In response to detecting the condition, processing of a work unit is initiated to generate a result. The result is transmitted to a target data system in a remote location.

### BACKGROUND OF THE INVENTION

1. Technical Field

The present invention relates generally to an improved data processing system, and in particular to a method and apparatus for processing data. Still more particularly, the present invention provides a method, apparatus, and computer implemented instructions for distributed computation using computers in vehicles.

2. Description of Related Art

The Internet, also referred to as an “internetwork”, is a set of computer networks, possibly dissimilar, joined together by means of gateways that handle data transfer and the conversion of messages from a protocol of the sending network to a protocol used by the receiving network. When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Additionally, many federal, state, and local government agencies are also employing Internet sites for informational purposes, particularly agencies, which must interact with virtually all segments of society such as the Internal Revenue Service and secretaries of state. Providing informational guides and/or searchable databases of online public records may reduce operating costs. Further, the Internet is becoming increasingly popular as a medium for commercial transactions. With respect to commerce on the Web, individual consumers and business use the Web to purchase various goods and services. In offering goods and services, some companies offer goods and services solely on the Web while others use the Web to extend their reach.

Another benefit made possible by the Internet is to enable processing of problems, which are intractable using modern day super computers. With the Internet, it is possible to take many of these “intractable” problems, divide them into small work units, and have each work unit process by one of hundreds, thousands, or even millions of network-connected computers.

Many large computation tasks can be decomposed into a number (sometimes a large number) of smaller computation tasks which, when their results are properly integrated, provide the solution to the overall task. SETI@home is a popular example of one such large task: a large amount of radio telescope data is collected, and small snippets of the data are sent out to subscribing machines around the world. The data is processed, the results are returned to the central collection point, and eventually all of the data is processed. Other tasks that are easily decomposed and distributed in this manner are Monte Carlo simulations and computer graphics (for instance, ray tracing of complex scenes). A work unit is typically a collection of data and functions that operate on that data. For instance, using an Object-Oriented programming language such as Java, a work unit might be a Class or a set of Classes that contain a set of data, plus methods to process that data. When a work unit is completed at a computer, the computer returns the result. Then, the computer may receive another work unit for processing.

It would be advantageous to have a method and apparatus for employing other types of computers, other than the traditional personal computers, for harnessing processing resources.

### SUMMARY OF THE INVENTION

The present invention provides a method, apparatus, and computer implemented instructions for distributed computing in a data processing system located in a vehicle. Monitoring for a condition in which processing resources are available in the data processing system is performed. In response to detecting the condition, processing of a work unit is initiated to generate a result. The result is transmitted to a target data system in a remote location.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a diagram of a network data processing system in accordance with a preferred embodiment of the present invention;

FIG. 2 is a block diagram of a data processing system that may be implemented as a server in accordance with a preferred embodiment of the present invention;

FIG. 3 is a diagram of a vehicle data processing system in accordance with a preferred embodiment of the present invention;

FIG. 4 is a diagram illustrating software components used in distributed computation using idle vehicle computers in accordance with a preferred embodiment of the present invention;

FIG. 5 is a flowchart of a process used to handle a processing request in accordance with a preferred embodiment of the present invention;

FIG. 6 is a flowchart of a process used for processing work units in accordance with a preferred embodiment of the present invention;

FIG. 7 is a flowchart of a process used for prioritizing processing of work units in accordance with a preferred embodiment of the present invention; and

FIG. 8 is a flowchart of a process for monitoring and reassigning work units in accordance with a preferred embodiment of the present invention.

### DETAILED DESCRIPTION OF THE PREFERRED EMBODIMENT

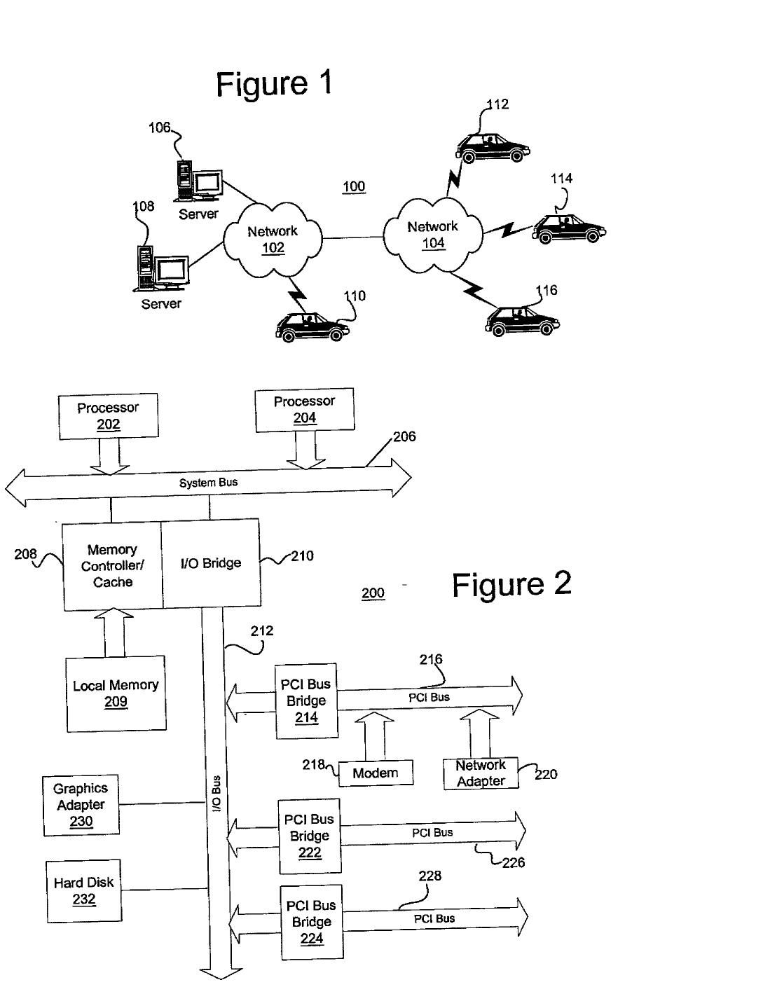

With reference now to the figures, and in particular to FIG. 1, a diagram of a network data processing system is depicted in accordance with a preferred embodiment of the present invention. Network data processing system 100 is an example of a system in which distributed computation may be perform in accordance with a preferred embodiment of the present invention. In this example, network data processing system 100 includes network 102 and network 104.

Server 106 and server 108 are connected to network 102 in these examples. Automobile 110 has a wireless communications link to network 102. Automobiles 112, 114, and 116 have wireless communications links to network 104.

In the depicted examples, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN).

Network 104, in this example, is a wireless network, which provides communications links to mobile devices, such a computers within automobiles 112, 114, and 116. The present invention recognizes that more and more computers are being incorporated into automobiles for a variety of purposes. The uses range from engine control functions to entertainment consol control to global positioning system (GPS) navigation systems. Computers located within automobiles 112, 114, and 116 are in communication with each other and other network data processing systems, such as server 106 in network 102. Various standards may be used to provide the wireless communications links.

In the depicted examples, a wireless technology, such as Bluetooth may be used to provide a wireless communications link. Bluetooth is a wireless personal area network (PAN) technology from the Bluetooth Special Interest Group. Bluetooth is an open standard for short-range transmission of digital voice and data between mobile devices (laptops, PDAs, phones) and desktop devices. This standard supports point-to-point and multi-point applications.

The present invention provides a method, apparatus, and computer implemented instructions for taking advantage of processing resources within vehicles. Vehicles with available or unused processing resources are provided with work units to process in these examples. In this manner, vehicle processors may be dedicated to processing work units in solving various computational problems. The owner of a vehicle may charge back a fee to the requester. Such a billing system is an especially cost effective mechanism for businesses with idle fleets of cars or other vehicles, such as automobiles and trucks in a rental fleet. FIG. 1 is intended as an example, and not as an architectural limitation for the present invention.

Referring to FIG. 2, a block diagram of a data processing system that may be implemented as a server, such as server 106 or 108 in FIG. 1, is depicted in accordance with a preferred embodiment of the present invention. In the depicted examples, data processing system 200 may coordinate and direct work units to various vehicles containing available processing resources.

Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to a network, such as network 102 in FIG. 1, may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

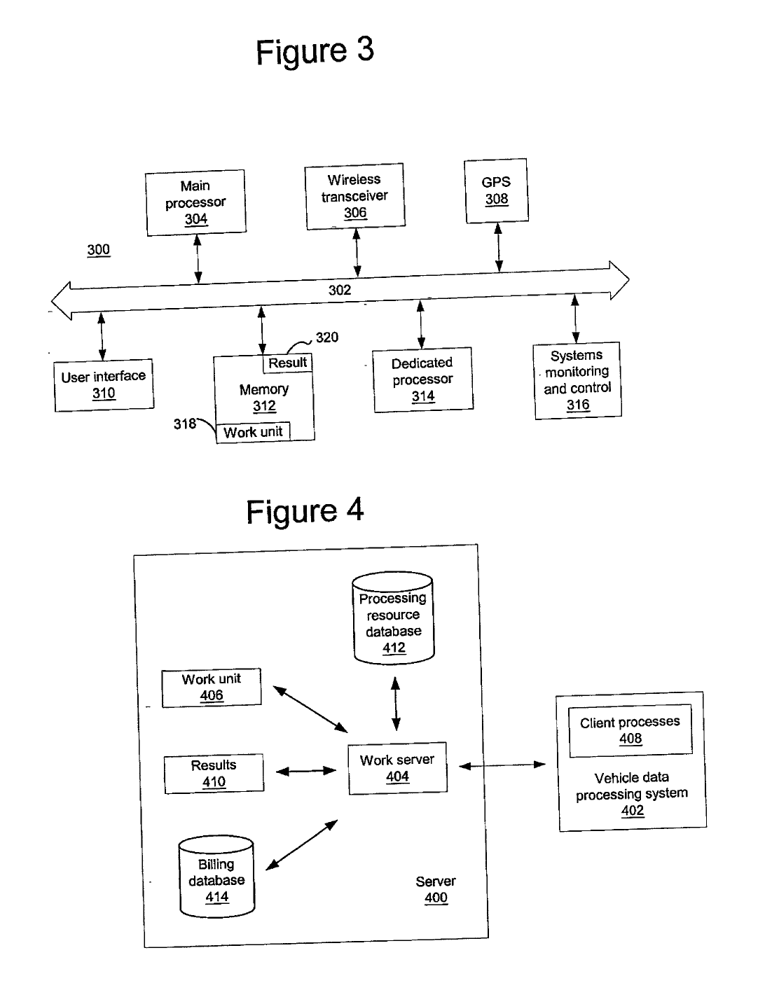

With reference now to FIG. 3, a diagram of a vehicle data processing system is depicted in accordance with a preferred embodiment of the present invention. Vehicle data processing system 300 may be located in a vehicle, such as automobile 110 or 112 in FIG. 1. Vehicle data processing system 300 also is referred to as an onboard computer.

In vehicle data processing system 300, bus 302 provides a connection for main processor 304, wireless transceiver 306, global positioning system (GPS) 308, user interface 310, memory 312, dedicated processor 314, and systems monitoring and control 316. Main processor 304 provides processing resources used in monitoring and controlling various systems in a vehicle. Wireless transceiver 306 provides a mechanism to establish a wireless communications links with a network, such as network 104 in FIG. 1. GPS 308 provides an ability to identify the location of the vehicle. User interface 310 allows a user to interact with vehicle data processing system 300. This interaction may be provided through various input and output devices, such as a touch screen liquid crystal display (LCD) or a speaker and a microphone. Systems monitoring and control 316 provides an ability to monitor and control various systems within the vehicle. For example, engine performance may be monitored and controlled through systems monitoring and control 316.

In these examples, Microsoft® Windows® CE for automotive systems may be implemented as the operating system in data processing system 300. Additionally, a Java virtual machine (JVM) also may be running on data processing system 300 to process work units through specialized Java beans. The processes for these Java beans are described in more detail below.

Dedicated processor 314 in this example is used to monitor the vehicle and determine when processing resources are available from main processor 304 to process a work unit, such as work unit 318 in memory 312. In the depicted examples, the work units are processed only when the vehicle is parked and not in use. As illustrated, when the car is parked previously stored work units are processed by main processor 304. When a work unit, such as work unit 318, is completed result 320 is stored in memory 312. Dedicated processor 314 transmits result 320 to a target data processing system through wireless transceiver 306.

Further, while processing of work units occur in the automobile, dedicated processor 314 also includes processes to monitor the battery power level in the automobile. If the battery power level drops below a selected threshold, all processing of work units ceases. The selected threshold may be, for example, the amount of battery power needed to start the engine in the automobile.

A wireless port may be placed in a garage where the automobile is normally parked or wireless ports may be placed in various locations, such as at a stop light. With the nature of distributed computing tasks, a constant network connection is not required. The connection is only required to receive work units and return results.

Turning now to FIG. 4, a diagram illustrating software components used in distributed computation using idle vehicle computers is depicted in accordance with a preferred embodiment of the present invention. In this example, server 400 receives and distributes work to vehicle data processing system 402. Server 400 may be implemented using data processing system 200 in FIG. 2, while vehicle data processing system 402 may be implemented using vehicle data processing system 300 in FIG. 3.

Work server 404 is a software component used to send work unit 406 to client processes 408 executing on vehicle data processing system 402. A process located within client processes 408 may be executed by main processor 304 in FIG. 3 in processing work units. Processes used for receiving work units, detecting availability of processing resources, and the returning of results may be executed by dedicated processor 314 in FIG. 3, in these examples. Results returned from client processes 408 are stored as results 410.

Processing resource database 412 is accessed by work server 404 to identify and assign work units to different vehicle data processing systems. A requester or other third party presenting the computational project may be billed using billing database 414. Billing may take various forms. For example, a customer may be billed for each work unit or on a flat monthly fee.

The various components depicted in FIGS. 1-4 are provided for purposes of illustration and are not intended to limit the architecture or components used in implementing invention.

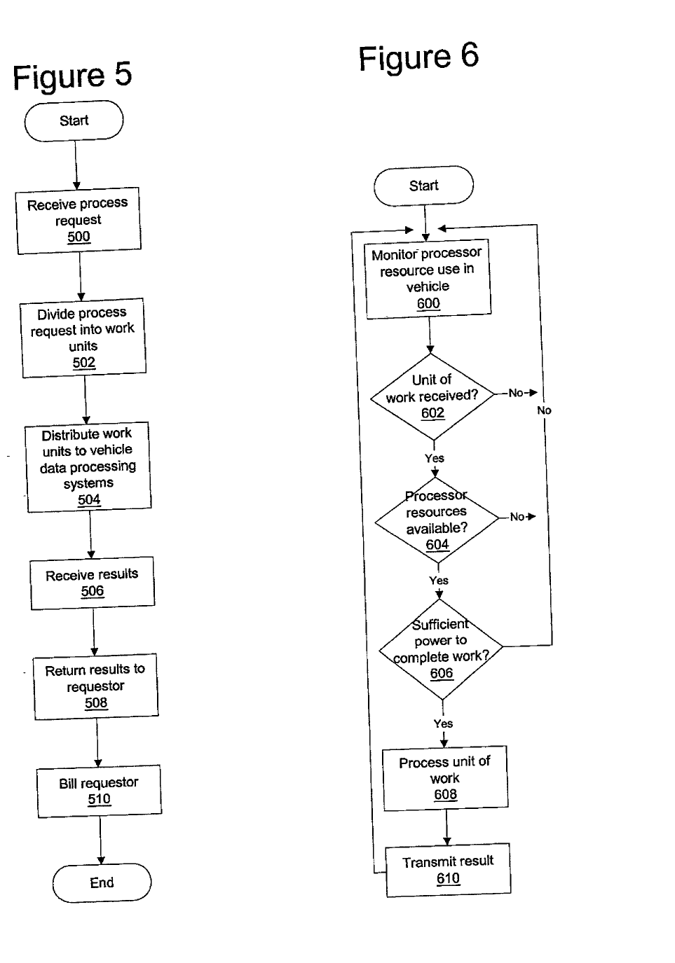

Turning next to FIG. 5, a flowchart of a process used to handle a processing request is depicted in accordance with a preferred embodiment of the present invention. The process illustrated in FIG. 5 may be implemented in a server, such as server 400 in FIG. 4.

The process begins by receiving a processing request (step 500). This request may be received from some third party desiring additional processing resources for particular problem or project. The processing request is divided into work units (step 502). The request may already contain the particular task subdivided as work units.

Next, the work units are distributed to vehicle data processing systems (step 504). These work units may be distributed as Java classes, which encapsulate data and the functions operated on the data for a work unit. The particular vehicle data processing systems receiving work units may be identified using a database, such as processing resource database 412 in FIG. 4. The results are received (step 506), and then returned to the requester (step 508). The requester is billed (step 510) with the process terminating thereafter. The billing may be handled using a billing database, such as billing database 414 in FIG. 4.

With reference now to FIG. 6, a flowchart of a process used for processing work units is depicted in accordance with a preferred embodiment of the present invention. The process illustrated in FIG. 6 may be implemented in a vehicle data processing system, such as vehicle data processing system 300 in FIG. 3.

The process begins by monitoring processor resource use in a vehicle (step 600). Next, a determination is made as to whether a work unit has been received from a source, such as server 400 in FIG. 4 (step 602). If a work unit has not been received, the process returns to step 600. Otherwise, a determination is made as to whether processor resources are available (step 604). In these examples, processor resources are available when the vehicle is parked and not in use. If no processor resources are available, the processor returns to step 600 as described above. One primary reason for using processor resources only when a vehicle is parked is to avoid having the vehicle performing a distributed computing task in the event an emergency situation occurs, such as a sudden use of the brakes to avoid a collision. For example, the determination is step 604 may be made by detecting whether a key is present in the ignition. Other conditions, such as detecting whether the motor is running, whether the transmission is in a “parked” mode, and whether a driver is detected in the seat of the vehicle, may be used to determine whether the vehicle is available for processing distributed computing tasks.

If processor resources are available, a determination is then made as to whether there is sufficient power to complete the work (step 606). The power in step 606 is the battery power in the vehicle. In these examples, sufficient power is available if the power level is such that the engine in the vehicle can be started. Of course, other threshold power levels may be used to account for other desired processing or uses of battery power. If insufficient power is available to complete the work, the process returns to step 600. Otherwise, the work unit is processed (step 608). Then, the result is transmitted to the source (step 610) with the process returning to step 600 as described above.

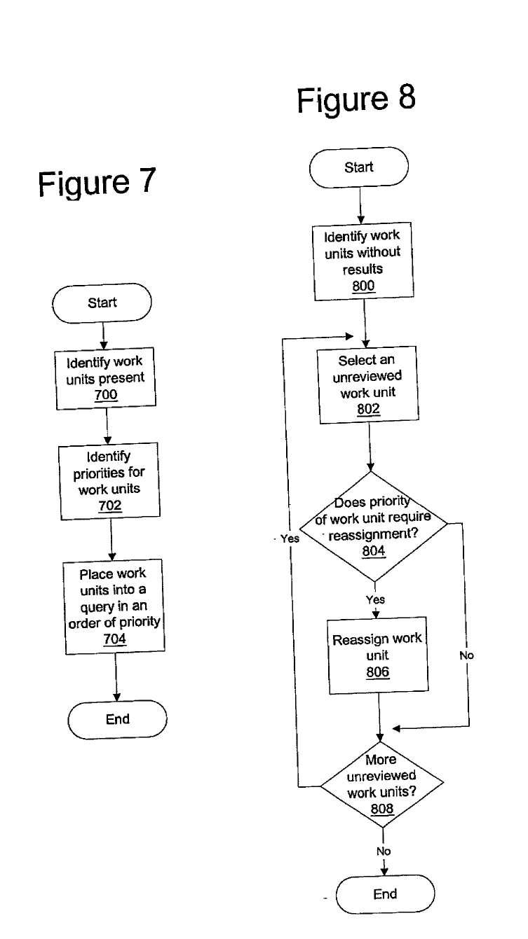

Turning now to FIG. 7, a flowchart of a process used for prioritizing processing of work units is depicted in accordance with a preferred embodiment of the present invention. The process illustrated in FIG. 7 may be implemented in a vehicle data processing system, such as vehicle data processing system 300 in FIG. 3.

The process begins by identifying work units present for processing (step 700). Priorities for the work unit are identified (step 702). Next, the work units are placed into a queue in an order of priority for processing (step 704) with the process terminating thereafter.

Turning next to FIG. 8, a flowchart of a process for monitoring and reassigning work units is depicted in accordance with a preferred embodiment of the present invention. The process illustrated in FIG. 8 may be implemented in a server process, such as work server 404 in FIG. 4.

The process begins by identifying work units without results (step 800). A un-reviewed work unit from the set work unit identified is selected for processing (step 802). A determination is then made as to whether the priority of the work unit requires reassignment of the work unit to another vehicle data processing system (step 804). In some cases, a work unit may have a priority requiring that it be completed within a certain period of time. Additionally, in some cases a vehicle may be unavailable to report results for some extended period of time. For example, if a car is parked by an owner who is gone on vacation in a remote area and unable to establish a communications link, the owner of the car may not return for some extended period of time, such as one or two weeks.

If the work unit requires reassignment, the work unit is then assigned to anther vehicle data processing system (step 806). In this instance, results from the original vehicle data processing system assigned the work unit are ignored if received at a later time. Additionally, a signal or message may be sent the original vehicle data processing system to flush or discard any results thus far. A determination is then made as to whether additional un-reviewed work units are present (step 808). If additional un-reviewed work units are present, the process returns to step 802. Otherwise, the process terminates. Turning back to step 804, if the priority of the work unit does not require reassignment, the process returns to step 808 as described above.

Thus, the present invention provides a method, apparatus, and computer implemented instructions for distributed computation using vehicle data processing systems. This mechanism allows for owners of vehicles to leverage vehicles as an income earning resource. This mechanism is especially advantageous for businesses owning fleets of vehicles.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for distributed computing in a data processing system located in a vehicle, the method comprising:
monitoring for a condition in the vehicle data processing system in which processing resources can be safely used for processing a work unit;
responsive to detecting the condition, initiating processing of the work unit to generate a result; and
transmitting the result to a target data system in a remote location.

2. The method of claim 1, wherein the condition is a time when the vehicle is parked.

3. The method of claim 1, wherein the condition is a time when the processing resources are not being used.

4. The method of claim 2 further comprising:
monitoring a battery power level in the vehicle.

5. The method of claim 1, wherein the result is transmitted using a wireless communications link.

6. The method of claim 2, wherein the vehicle is parked if the engine is stopped.

7. The method of claim 1, wherein the processing resources are provided by a first processor in the data processing system and wherein the monitoring step, the initiating step, and the transmitting step are performed by a second processor in the data processing system.

8. The method of claim 1, wherein the monitoring step includes determining whether a key is present in an ignition for the vehicle.

9. A method for processing a work unit in a vehicle data processing system located in a vehicle, the method comprising:
monitoring the vehicle to determine when processing resources can be safely used for processing the work unit; and
responsive to detecting a time in which processing resources can be safely used for processing the work unit, allocating processor resources within the vehicle data processing system to process the work unit.

10. The method of claim 9 further comprising:
returning a result generated from processing of the work unit to a requestor.

11. The method of claim 9 further comprising:
initiating the allocating step only if a sufficient battery power level is present within the vehicle.

12. A data processing system comprising:
a bus system;
a communications unit connected to the bus system;
a memory connected to the bus system, wherein the memory includes as set of instructions; and
a processing unit connected to the bus system, wherein the processing unit executes the set of instructions to monitor for a condition in the vehicle data processing system in which processing resources can be safely used for processing a work unit; initiate processing of the work unit to generate a result in response to detecting the condition; and transmit the result to a target data system in a remote location.

13. A data processing system comprising:
a bus system;
a communications unit connected to the bus system;
a memory connected to the bus system, wherein the memory includes as set of instructions; and
a processing unit connected to the bus system, wherein the processing unit executes the set of instructions to monitor the vehicle to determine when the vehicle is parked; and allocate processor resources within the vehicle data processing system to process the work unit in response to identifying a time in which the vehicle is parked.

14. A data processing system for distributed computing in a data processing system located in a vehicle, the data processing system comprising:
monitoring means for monitoring for a condition in the vehicle data processing system in which processing resources can be safely used for processing a work unit;
initiating means, responsive to detecting the condition, for initiating processing of the work unit to generate a result; and
transmitting means for transmitting the result to a target data system in a remote location.

15. The data processing system of claim 14, wherein the condition is a time when the vehicle is parked.

16. The data processing system of claim 14, wherein the condition is a time when the processing resources are not being used.

17. The data processing system of claim 15, wherein the monitoring means is a first monitoring means and further comprising:
second monitoring means for monitoring a battery power level in the vehicle.

18. The data processing system of claim 14, wherein the result is transmitted using a wireless communications link.

19. The data processing system of claim 16, wherein the vehicle is parked if the engine is stopped.

20. The data processing system of claim 14, wherein the processing resources are provided by a first processor in the data processing system and wherein the monitoring means, the initiating means, and the transmitting means are performed by a second processor in the data processing system.

21. The data processing system of claim 14, wherein the monitoring means includes determining whether a key is present in an ignition for the vehicle.

22. A data processing system for processing a work unit in a vehicle data processing system located in a vehicle, the data processing system comprising:
monitoring means for monitoring the vehicle to determine when the vehicle is parked; and
allocating means, responsive to identify a time in which the vehicle is parked, for allocating processor resources within the vehicle data processing system to process the work unit.

23. The data processing system of claim 22 further comprising:
returning means for returning a result generated from processing of the work unit to a requester.

24. The data processing system of claim 22 further comprising:
initiating means for initiating the allocating step only if a sufficient battery power level is present within the vehicle.

25. A computer program product in a computer readable medium for distributed computing in a data processing system located in a vehicle, the computer program product comprising:
first instructions for monitoring for a condition in the vehicle data processing system in which processing resources can be safely used for processing a work unit;
second instructions, responsive to detecting the condition, for initiating processing of the work unit to generate a result; and
third instructions for transmitting the result to a target data system in a remote location.

26. The computer program product of claim 25, wherein the condition is a time when the vehicle is parked.

27. The computer program product of claim 25, wherein the condition is a time when the processing resources are not being used.

28. The computer program product of claim 26 further comprising:
fourth instructions for monitoring a battery power level in the vehicle.

29. The computer program product of claim 25, wherein the result is transmitted using a wireless communications link.

30. The computer program product of claim 27, wherein the vehicle is parked if the engine is stopped.

31. The computer program product of claim 25, wherein the processing resources are provided by a first processor in the data processing system and wherein the monitoring step, the initiating step, and the transmitting step are performed by a second processor in the data processing system.

32. The method of claim 25, wherein the first instructions includes determining whether a key is present in an ignition for the vehicle.

33. A computer program product in a computer readable medium for processing a work unit in a vehicle data processing system located in a vehicle, the computer program product comprising:
first instructions for monitoring the vehicle to determine when the vehicle is parked; and
second instructions, responsive to identify a time in which the vehicle is parked, for allocating processor resources within the vehicle data processing system to process the work unit.

34. The computer program product of claim 33 further comprising:
third instructions for returning a result generated from processing of the work unit to a requester.

35. The computer program product of claim 33 further comprising:
third instructions for initiating the allocating step only if a sufficient battery power level is present within the vehicle.
